(19) United States
(12) Patent Application Publication
(10) Pub. No.: US 2005/0089450 A1
(43) Pub. Date: Apr. 28, 2005

(54) Pipette with multiple sealing zones

(75) Inventors: Kassab Al-Mahareeq, Indianapolis, IN (US); Hasan Al-Mahrouq, Indianapolis, IN (US)

Correspondence Address: Paul B. Overhauser, 479 Sycamore Court, Greenfield, IN, 46146, US

(73) Assignee: Integrated Instrument Services, Inc., Indianapolis, IN (US)

(21) Appl. No.: 10/693,389

(22) Filed: Oct. 27, 2003

(51) Int. Cl. B01L 3/02

(52) U.S. Cl. 422/100

(57) ABSTRACT

A pipette has a pipette tip mounting shaft having multiple sealing zones, with each sealing zone abutting a stop, which prevents a pipette tip from being placed on the shaft with excessive force. As a result, differently sized pipette tips, can be sealingly engaged on the shaft, and each can be ejected with a minimal amount of force.

### FIELD OF THE INVENTION

This invention relates to pipettes, and, in particular, to pipettes capable of accommodating pipette tips of varying geometries.

### BACKGROUND OF THE INVENTION

Pipettes have been widely used in liquid handling systems, e.g., U.S. Pat. No. 4,263,257 to Metsala and U.S. Pat. No. 4,268,481 to Suovaniemi, et al. U.S. Pat. No. 6,168,761 to Lelly et. al. and U.S. Pat. No. 6,568,288 to Rainin. Pipettes generally have two plungers, one for liquid control and the other for ejection of pipette tips. Pipette users often use pipettes for substantial time periods, and the repetitive operation of the plungers can result in significant fatigue, pain and long term disabilities such a repetitive motion disorder. This problem is exacerbated when a strong force is required to eject the pipette tip from the pipette. Moreover, different pipette tip manufacturers make tips of differing geometries, so there can be great variance in the amount of force that must be applied to a tip to adhere it to the pipette, and to eject it from the pipette.

Accordingly, it is desirable to provide a pipette that allows attachment of pipette tips with a minimal amount of force, ejection of tips with a minimal amount of force, and which works with pipette tips of various geometries. It is further desirable to provide a pipette capable of accommodating pipette tips of multiple manufacturers while still allowing each type of pipette tip to be secured to, and ejected from, the pipette mounting shaft with a minimal amount of force.

### SUMMARY OF THE INVENTION

A pipette has a pipette tip mounting shaft having multiple sealing zones, with each sealing zone abutting a stop, which prevents a pipette tip from being placed on the shaft with excessive force. As a result, differently sized pipette tips, can be sealingly engaged on the mounting shaft, and each tip can be ejected with a minimal amount of force.

### BRIEF DESCRIPTION OF THE DRAWINGS

FIG. 1 is a side view of a pipette tip mounting shaft in accordance with the present invention.

FIG. 2 is a side sectional view of a pipette tip mounting shaft and pipette tip with a smaller diameter pipette tip thereon.

FIG. 3 is a side sectional view of a pipette tip mounting shaft and pipette tip with a larger diameter pipette tip thereon.

### DETAILED DESCRIPTION

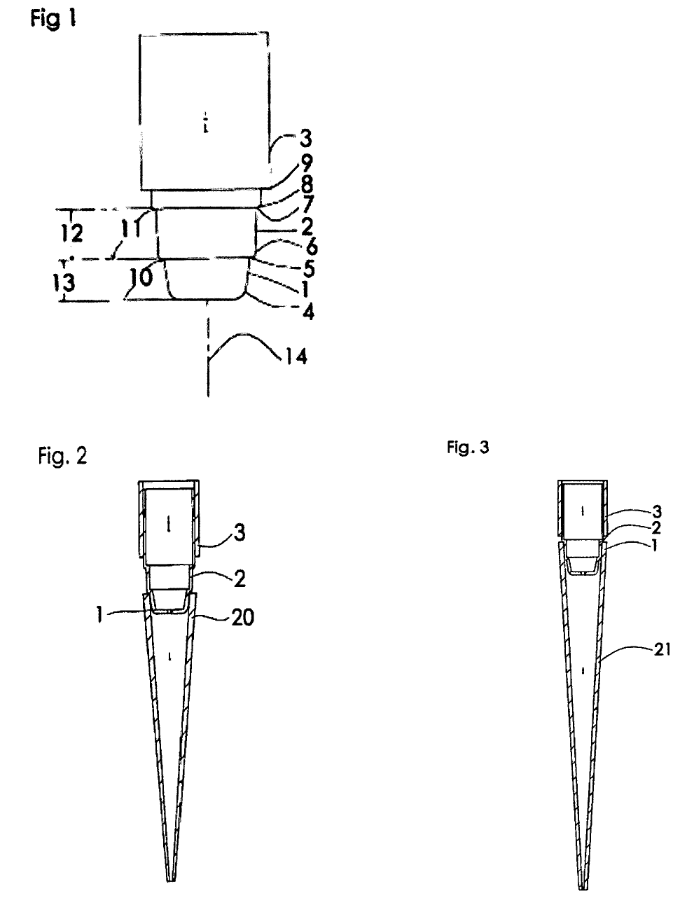

FIG. 1 is a side view of an air displacement pipette mounting tip in accordance with the present invention. The surfaces shown in this side view are circular around axis 14.

The tapers shown in sealing zones 1, 2 have been exaggerated to assist in explaining the invention, and are conical in shape. In practice, the tapers will instead have the dimensions described below. Pipette tip ejector 3 has an annual cross section and is axially movable downward with respect to a pipette tip mounting shaft, from the position shown past first annular pipette tip stop 5. Pipette tip mounting shaft includes first and second pipette conically tapered sealing zones 1, 2, each being coaxial along axis 14. The narrow end 4 of first sealing zone 1 has an outer diameter of 0.11 to 0.13 inches, while the wide end 5 has an outer diameter of 0.15 to 0.19 inches. First sealing zone 1 is also 0.15 to 0.20 in. long, and therefore has a taper at an angle of 84 to 90 degrees with respect to the plane perpendicular to axis 14. It will be appreciated that throughout this specification, the word “taper” is used, although if an angle of 90 degrees is used, this will not actually be a taper.

In a second embodiment for holding medium-sized pipette tips, the narrow end 4 of first sealing zone 1 has an outer diameter of 0.18 to 0.20 inches, while the wide end 5 has an outer diameter of 0.20 to 0.22 inches. First sealing zone 1 is also 0.10 to 0.15 in. long, and therefore has a taper at an angle of 84 to 90 degrees with respect to the plane perpendicular to axis 14.

In a third embodiment for holding large pipette tips, the narrow end 4 of first sealing zone 1 has an outer diameter of 0.25 to 0.28 inches, while the wide end 5 has an outer diameter of 0.28 to 0.30 inches. First sealing zone 1 is also 0.13 to 0.15 in. long, and therefore has a taper at an angle of 84 to 90 degrees with respect to the plane perpendicular to axis 14.

First sealing zone 1 may be inserted into the top of a pliable pipette tip of a first size, which will be sealingly retained on the tip via a friction fit. However, first pipette tip stop, defined by inner edge 5 and outer edge 6, prevent a pipette tip from being inserted too far up on the mounting shaft. This stop abuts and is coaxial with the first and second sealing zones and is substantially perpendicular to the axis defining the first and second conically tapered sealing zones. It also has an inner diameter equal to the wide end of the first sealing zone and an outer diameter equal to the narrow end of the second sealing zone. When it is time to eject the pipette tip from the first sealing zone, ejector 3 is depressed. Because of the cooperating geometry of first sealing zone 1, first stop 5,6 and the pipette tip, the pipette tip will not be engaged so tightly so as to be difficult to eject. In particular, a force of less than 0.8 kg (1.8 lbs.) will be required to eject the pipette tip from the mounting shaft. This compares favorably to the ejection force of typical pipettes, which require 4 kg. or 8.8 lbs. of force.

The present invention also accommodates pipette tips of different sizes, and multiple stops prevent each differently sized pipette from being too tightly secured to the pipette tip mounting shaft to require excessive force to eject the tip. Specifically, the pipette mounting shaft may be inserted into a pipette tip with a wider internal diameter until it sealingly engages second sealing surface 2, which is also conical in shape and coaxial with first sealing surface 1. The narrow end 6 of second sealing zone 2 has an outer diameter of 0.20 to 0.21 inches, while the wide end 7 has an outer diameter of 0.22 to 0.23 inches. Second sealing zone 2 is also 0.53 to 0.63 in. long, and therefore has a taper at an angle of 86 to 90 degrees with respect to the plane perpendicular to axis 14.

In a second embodiment for holding medium-sized pipette tips, the narrow end 6 of second sealing zone 2 has an outer diameter of 0.22 to 0.24 inches, while the wide end 7 has an outer diameter of 0.24 to 0.26 inches. Second sealing zone 2 is also 0.13 to 0.17 in. long, and therefore has a taper at an angle of 86 to 90 degrees with respect to the plane perpendicular to axis 14.

In a third embodiment for holding large pipette tips, the narrow end 6 of second sealing zone 2 has an outer diameter of 0.30 to 0.32 inches, while the wide end 7 has an outer diameter of 0.32 to 0.34 inches. Second sealing zone 2 is also 0.15 to 0.17 in. long, and therefore has a taper at an angle of 86 to 90 degrees with respect to the plane perpendicular to axis 14.

It will be appreciated by those of skill in the art that regardless of the size of the pipette tip mounting on the mounting shaft, the upper edge of the pipette tip should be wide enough so that it is struck by ejector 3 when depressed, to thereby eject the pipette tip from the pipette tip mounting shaft.

FIG. 2 is a side sectional view of a pipette tip mounting shaft and pipette tip with a smaller diameter pipette tip thereon. As shown, the interior upper surface of pipette tip 20 sealingly engages first sealing zone 1, yet the upper width of the pipette tip is wide enough to be engaged by ejector 3 when it is depressed.

FIG. 3 is a side sectional view of a pipette tip mounting shaft and pipette tip with a larger diameter pipette tip thereon. As shown, the interior upper surface of pipette tip 21 sealingly engages second sealing zone 2, yet the upper width of the pipette tip is wide enough to be engaged by ejector 3 when it is depressed.

It will be understood that various details of the invention may be changed without departing from the spirit and scope of the invention. Furthermore, the foregoing description is for illustration only, and not for the purpose of limitation, the invention being defined by the claims. For example, three or more tapered sealing zones, each having a stop that defining its upper edge may be incorporated into a pipette tip mounting shaft to thereby allow an even wider variety of sizes of pipette tips to be used.

The references cited in this specification are incorporated herein by reference to the extent that they supplement, explain, provide a background for or teach methodology or techniques employed herein.

1. A pipette comprising:
a pipette tip ejector axially movable with respect to a pipette tip mounting shaft,
the pipette tip mounting shaft comprising:
a first conically tapered sealing zone, the first sealing zone comprising
a narrow end with an outer diameter of 0.11 to 0.13 inches,
a wide end with an outer diameter of 0.15 to 0.19 inches;
and being 0.15 to 0.20 in. long, to thereby form a tapered at an angle of 84 to 90 degrees with respect to the plane perpendicular to the axis of the first sealing zone;
a second conically tapered sealing zone, the second sealing zone being coaxial with the first sealing zone and comprising
a narrow end with an outer diameter of 0.20 to 0.21 inches,
a wide end with an outer diameter of 0.22 to 0.23 inches;
and being 0.53 to 0.63 in. long, to thereby form a tapered at an angle of 86 to 90 degrees with respect to the plane perpendicular to the axis of the first sealing zone;
a first annular pipette tip stop between and abutting and being coaxial with the first and second sealing zones, and further:
being substantially perpendicular to the axis defining the first and second conically tapered sealing zones; and
having an inner diameter equal to the wide end of the first sealing zone and an outer diameter equal to the narrow end of the second sealing zone;
a second annual pipette tip stop abutting the second sealing zone, the second stop:
being perpendicular to the axis defining the first and second conically tapered sealing zones,
having an inner diameter equal to the wide end of the second sealing zone.

2. A pipette comprising:
a pipette tip ejector axially movable with respect to a pipette tip mounting shaft,
the pipette tip mounting shaft comprising:
a first conically tapered sealing zone, the first sealing zone comprising
a narrow end with an outer diameter of 0.18 to 0.20 inches,
a wide end with an outer diameter of 0.20 to 0.22 inches;
and being 0.10 to 0.15 in. long, to thereby form a tapered at an angle of 84 to 90 degrees with respect to the plane perpendicular to the axis of the first sealing zone;
a second conically tapered sealing zone, the second sealing zone being coaxial with the first sealing zone and comprising
a narrow end with an outer diameter of 0.22 to 0.24 inches,
a wide end with an outer diameter of 0.24 to 0.26 inches;
and being 0.13 to 0.17 in. long, to thereby form a tapered at an angle of 86 to 90 degrees with respect to the plane perpendicular to the axis of the first sealing zone;
a first annular pipette tip stop between and abutting and being coaxial with the first and second sealing zones, and further:
being substantially perpendicular to the axis defining the first and second conically tapered sealing zones; and
having an inner diameter equal to the wide end of the first sealing zone and an outer diameter equal to the narrow end of the second sealing zone;
a second annual pipette tip stop abutting the second sealing zone, the second stop:
being perpendicular to the axis defining the first and second conically tapered sealing zones,
having an inner diameter equal to the wide end of the second sealing zone.

3. A pipette comprising:
a pipette tip ejector axially movable with respect to a pipette tip mounting shaft,
the pipette tip mounting shaft comprising:
a first conically tapered sealing zone, the first sealing zone comprising
a narrow end with an outer diameter of 0.25 to 0.28 inches,
a wide end with an outer diameter of 0.28 to 0.30 inches;
and being 0.13 to 0.15 in. long, to thereby form a tapered at an angle of 84 to 90 degrees with respect to the plane perpendicular to the axis of the first sealing zone;
a second conically tapered sealing zone, the second sealing zone being coaxial with the first sealing zone and comprising
a narrow end with an outer diameter of 0.30 to 0.32 inches,
a wide end with an outer diameter of 0.32 to 0.34 inches;
and being 0.15 to 0.17 in. long, to thereby form a tapered at an angle of 86 to 90 degrees with respect to the plane perpendicular to the axis of the first sealing zone;
a first annular pipette tip stop between and abutting and being coaxial with the first and second sealing zones, and further:
being substantially perpendicular to the axis defining the first and second conically tapered sealing zones; and
having an inner diameter equal to the wide end of the first sealing zone and an outer diameter equal to the narrow end of the second sealing zone;
a second annual pipette tip stop abutting the second sealing zone, the second stop:
being perpendicular to the axis defining the first and second conically tapered sealing zones,
having an inner diameter equal to the wide end of the second sealing zone.

4. A pipette comprising:
a pipette tip ejector axially movable with respect to a pipette tip mounting shaft,
the pipette tip mounting shaft comprising:
a first sealing zone, comprising
upper and lower ends, and
which is at an angle of 84 to 90 degrees with respect to the plane perpendicular to the axis of the first sealing zone;
a second sealing zone being coaxial with the first sealing zone and comprising
upper and lower ends and,
which is at an angle of 84 to 90 degrees with respect to the plane perpendicular to the axis of the second sealing zone;
a first annular pipette tip stop between and abutting and being coaxial with the first and second sealing zones, and further:
being substantially perpendicular to the axis defining the first and second conically tapered sealing zones; and
having an inner diameter equal to the top end of the first sealing zone and an outer diameter equal to the lower end of the second sealing zone;
a second annual pipette tip stop abutting the second sealing zone, the second stop:
being perpendicular to the axis defining the first and second conically tapered sealing zones, and
having an inner diameter equal to the top end of the second sealing zone.
